(19) United States
(12) Patent Application Publication
(10) Pub. No.: US 2025/0104727 A1
(43) Pub. Date: Mar. 27, 2025

(54) SINGLE-CHANNEL SPEECH ENHANCEMENT USING ULTRASOUND

(71) Applicant: The Regents of the University of California, Oakland, CA (US)

(72) Inventors: Xinyu Zhang, San Diego, CA (US); Ke Sun, San Diego, CA (US)

(21) Appl. No.: 18/730,041

(22) PCT Filed: Jan. 20, 2023
(86) PCT No.: PCT/US2023/061047

§ 371 Date: Jul. 18, 2024

Related U.S. Application Data
(60) Provisional application No. 63/301,461, filed on Jan. 20, 2022.

(51) Int. Cl. G10L 21/0224; G10L 15/25; G10L 21/0232

(52) U.S. Cl. CPC G10L 21/0224; G10L 15/25; G10L 21/0232

(57) ABSTRACT

In some embodiments, there is provided a method including receiving, by a machine learning model, first data corresponding to noisy audio including audio of a target speaker of interest proximate to a microphone; receiving, by the machine learning model, second data corresponding to articulatory gestures sensed by the microphone which also detected the noisy audio, wherein the second data corresponding to the articulatory gestures comprises one or more Doppler data indicative of Doppler associated with the articulatory gestures of the target speaker while speaking the audio; combining, by the machine learning model, a first set of features for the first data and a second set of features for the second data to form an output representative of the audio of the target speaker. Related systems, methods, and articles of manufacture are also disclosed.

### CROSS REFERENCE TO RELATED APPLICATION

This application claims priority to U.S. Provisional Application No. 63/301,461 entitled “SINGLE-CHANNEL SPEECH ENHANCEMENT USING ULTRASOUND” and filed on Jan. 20, 2022, which is incorporated herein by reference in its entirety.

### STATEMENT OF GOVERNMENT SUPPORT

This invention was made with government support under CNS-1954608 awarded by the National Science Foundation. The government has certain rights in the invention.

### SUMMARY

In one aspect, there is provided systems and methods for speech enhancement based on ultrasound.

In some embodiments, there is provided a method including receiving, by a machine learning model, first data corresponding to noisy audio including audio of a target speaker of interest proximate to a microphone; receiving, by the machine learning model, second data corresponding to articulatory gestures sensed by the microphone which also detected the noisy audio, wherein the second data corresponding to the articulatory gestures comprises one or more Doppler data indicative of Doppler associated with the articulatory gestures of the target speaker while speaking the audio; generating, by the machine learning model, a first set of features for the first data and a second set of features for the second data; combining, by the machine learning model, the first set of features for the first data and the second set of features for the second data to form an output representative of the audio of the target speaker that reduces, based on the combined first and second features, noise and/or interference related to at least one other speaker and/or related at least one other source of audio; and providing, by the machine learning model, the output representative of the audio of the target speaker.

In some variations of the methods, systems, and computer program products, one or more of the following features can optionally be included in any feasible combination. The method may further include emanating, via a loudspeaker, ultrasound towards at least the target speaker, wherein the ultrasound is reflected by the articulatory gestures and detected by the microphone. The method may further include receiving an indication of an orientation of a user equipment including the microphone and the loudspeaker; and selecting, using the received indication, the machine learning model. The ultrasound includes a plurality of continuous wave (CW) single frequency tones. The articulatory gestures include gestures associated with the target speaker's speech including mouth gestures, lip gestures, tongue gestures, jaw gestures, vocal cord gestures, and/or other speech related organs. The generating, by the machine learning model, the first set of features for the first data and the second set of features for the second data may further include using, a first set of convolutional layers to provide feature embedding for the first data, wherein the first data is in a time-frequency domain and using, a second set of convolutional layers to provide feature embedding for the second data, wherein the second data is in the time-frequency domain. The first set of features and the second set of features are combined in the time-frequency domain while maintaining time alignment between the first and second set of features. The machine learning model includes one or more fusion layers to combine, in a frequency domain, the first set of features for the first data and the second set of features for the second data. A single stream of data (which is obtained from the microphone) is received and preprocessed to extract the first data comprising noisy audio and to extract the second data comprising the articulatory gestures. The phase of the output representative of the audio of the target speaker is phase corrected. During training of the machine learning model, a generator comprising the machine learning model is used to output a noise-reduced representation of audible speech of the target speaker, and a discriminator is used to receive as a first input the noise-reduced representation of audible speech of the target speaker, receive as a second input a noisy representation of audible speech of the target speaker, and output, using a cross modal similarity metric, a cross-modal indication of similarity to train the machine learning model.

Implementations of the current subject matter can include, but are not limited to, systems and methods consistent including one or more features are described as well as articles that comprise a tangibly embodied machine-readable medium operable to cause one or more machines (e.g., computers, etc.) to result in operations described herein. Similarly, computer systems are also described that may include one or more processors and one or more memories coupled to the one or more processors. A memory, which can include a computer-readable storage medium, may include, encode, store, or the like one or more programs that cause one or more processors to perform one or more of the operations described herein. Computer implemented methods consistent with one or more implementations of the current subject matter can be implemented by one or more data processors residing in a single computing system or multiple computing systems. Such multiple computing systems can be connected and can exchange data and/or commands or other instructions or the like via one or more connections, including but not limited to a connection over a network (e.g., the Internet, a wireless wide area network, a local area network, a wide area network, a wired network, or the like), via a direct connection between one or more of the multiple computing systems, etc.

The details of one or more variations of the subject matter described herein are set forth in the accompanying drawings and the description below. Other features and advantages of the subject matter described herein will be apparent from the description and drawings, and from the claims. While certain features of the currently disclosed subject matter are described for illustrative purposes in relation to optical edge detection, it should be readily understood that such features are not intended to be limiting. The claims that follow this disclosure are intended to define the scope of the protected subject matter.

### DESCRIPTION OF THE DRAWINGS

In the drawings,

FIG. 1 depicts an example a system, in accordance with some embodiments;

FIG. 2 depicts examples of speech spectrograms and corresponding ultrasound Doppler spectrogram, in accordance with some embodiments;

FIG. 3A depicts an example implementation of a machine learning (ML) model including a deep neural network (DNN) framework, in accordance with some embodiments;

FIG. 3B depicts the ML model of FIG. 3A extended to include a time-frequency domain transformation and phase correction, in accordance with some embodiments;

FIG. 4 depicts an example of a conditional generative adversarial network (cGAN) used to train the ML model of FIGS. 3A-3B, in accordance with some embodiments;

FIG. 5 depicts an example of pre-processing, in accordance with some embodiments;

FIG. 6A depicts an example of a discriminator (D) used in the cGAN, in accordance with some embodiments;

FIG. 6B depicts probability density functions for the discriminator of FIG. 6A, in accordance with some embodiments;

FIG. 7 depicts holding orientations of the user equipment, in accordance with some embodiments;

FIG. 8 depicts an example of a process, in accordance with some embodiments;
and

FIG. 9 depicts another example of a system, in accordance with some embodiments.

### DETAILED DESCRIPTION

Robust speech enhancement is a goal and a requirement of audio processing to enable for example human-human and/or human-machine interaction. Solving this task remains an open challenge, especially for practical scenarios involving a mixture of competing speakers and background noise.

In some embodiments disclosed herein, there is provided systems, methods, and articles of manufacture that use ultrasound sensing as a complementary modality to process (e.g., separate) a desired speaker's speech from interference and/or noise.

In some embodiments, a user equipment, such as a smartphone, mobile phone, IoT device, and/or other device) may emit an ultrasound signal and receive (1) the ultrasound reflections from the speaker's articulatory gestures and receive (2) the noisy speech from the speaker. The phrase articulatory gestures refer to mouth, lips, tongue, jaw, vocal cords, and other speech related organs associated with the articulation of speech. In some implementations, the use of the microphone at the user equipment to receive the ultrasound reflections from the speaker's articulatory gestures and the noise speech from the speaker may provide an advantage of synchronizing the two heterogeneous modalities (i.e., the speech and ultrasound modalities).

In some embodiments, the (1) ultrasound reflections from the speaker's articulatory gestures are received and processed to detect the Doppler shift of the articulatory gestures. In some embodiments, the noisy speech (which includes the speaker's speech as well as interference and/or noise such as from other speakers and sources of sound) is processed into a spectrogram. In other words, the target (or desired) speech is embedded in the noisy speech, which can make it difficult to discern the target speaker's speech.

In some embodiments, at least one machine learning (ML) model may be used to process the ultrasonic Doppler features (which correspond to the speaker's auditory gestures) and the audible speech spectrogram (which includes the speaker's speech as well as interference and/or noise such as from other speakers and sources of sound) to output speech which has been enhanced by improving speech intelligibility and quality (e.g., by reducing if not eliminating some of the interference, such as noise caused by background speakers or other sources of sound). In other words, the ultrasonic Doppler features can be used by the ML model to correlate with the speaker's speech (and thus reduce or eliminate the noise or interference not associated with the speaker's speech and articulatory gestures).

In some embodiments, the at least one ML model may include an adversarially trained discriminator (e.g., based on a cross-modal similarity measurement network) that learns the correlation between the two heterogeneous feature modalities of the Doppler features and the audible speech spectrogram.

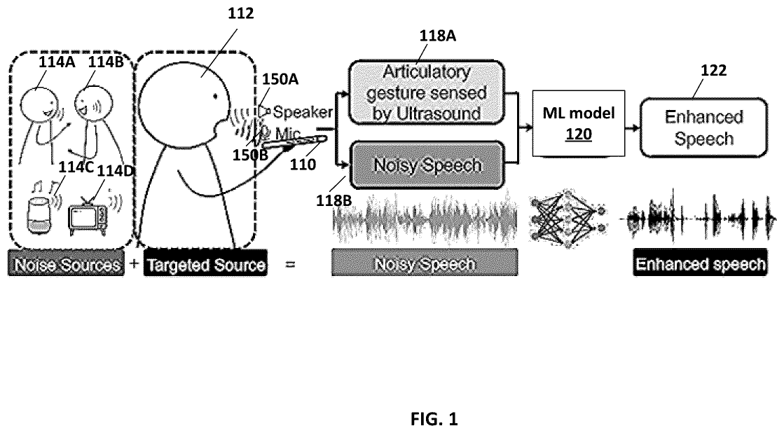

FIG. 1 depicts an example a system, in accordance with some embodiments. The system may include a user equipment 110. In the example of FIG. 1, the user equipment emits ultrasound. For example, a transducer, such as a loudspeaker 150A may transmit ultrasound towards a desired person speaking (“speaker”) 112. The ultrasound operates a frequency above the range of human hearing (e.g., above about 16 kilohertz (kHz), 17 kHz, 18 kHz, 19 kHz, 20 kHz, and/or the like). The user equipment may also include a microphone (Mic) 150B that receives the ultrasound reflections from the speaker's articulatory gestures and the noisy speech (which includes the speech audio from the desired speaker 112 as well as noise/interference). In the example of FIG. 1, some of the noise (and/or interference) may include noise from other speakers 114A-B and/or other sound sources 114C-D.

As noted, the user equipment 110 may receive at the microphone 150B the ultrasound and noisy speech and store (e.g., record) the received signals corresponding to the ultrasound and noisy speech from processing. During the voice recording, the user equipment may transmit (e.g., emit) inaudible ultrasound wave(s). This ultrasound transmission may be continuous during the voice recording phase. The transmitted ultrasound waves may be modulated by the speaker's articulatory gestures. For example, the speaker's 112 lip movement (which is for example within 18 inches of the speaker 112) modulates the ultrasound waves, although other auditory gestures such as movement of tongue, teeth, throat, and/or the like) may also modulate the ultrasound as well. The modulated ultrasound is then received by microphone 150B along with the noisy speech (which includes the speech of the desired speaker 112 as well as the noise/interference 114A-D). Moreover, the received ultrasound 118A and received noisy speech 118B may be stored (e.g., recorded) for processing by at least one ML model 120. The ML model may be implemented at the user equipment 110. Alternatively, or additionally, the ML model may be implemented at another device (e.g., a server, cloud server, and/or the like). Although the received noisy speech includes the speech of the desired speaker 112 (as well as the noise/interference 114A-D), the received ultrasound for the most part only captures the targeted speaker's 112 articulatory gesture motion (which can be correlated with the speaker's 112 speech).

In some embodiments, the ML model 120 may comprise a deep neural network (DNN) system that captures the correlation between the received ultrasound's articulatory gestures 118A and the received noisy speech 118B, and this correlation may be used to enhance (e.g., denoise, which refers to reducing or eliminating noise and/or interference) the noisy speech from the output 122 of enhanced speech. For example, the speaker's 112 speech may include the term “to.” In this example, the received ultrasound sensed by the microphone 150B may include the articulatory gestures (e.g., lip and/or tongue movement), which can be correlated to the term “to” in the noisy speech that is also received by the microphone 150B. This correlation may be used to process the noisy speech so that the “to” can be enhanced, while the noise and interference is reduced and/or filtered/suppressed.

Before providing additional description about the system of FIG. 1, the following provides information regarding the relationship between speech and articulatory gestures.

Human speech generation involves multiple articulators, such as tongue, lips, jaw, teeth, vocal cords, and other speech related organs. Coordinated movement of the articulators, such as the lip protrusion and closure, tongue stretch and constriction, jaw angle change, and/or the like may be used to at least in part define one or more phonological units (e.g., a phoneme in phonology and linguistics). Assuming that articulatory gestures can be fully captured and interpreted, it would be possible to recover using articulatory gestures the speech signals but in practice it is challenging to capture the fine-grained gesture motion of all articulators by using only articulatory gestures as some of the articulators are close to each other, some articulators can be inside the mouth/throat (so it is hard to discriminate their motion), and the articulatory gestures can be fast and subtle. For example, an articulatory gesture may last between about 100 and 700 millisecond (ms) and may involve less than about 5 centimeters (cm) of moving distance in the case of for example lip and jaw. Rather than recover speech only using the articulatory gestures, the system of FIG. 1 fuses the articulatory gestures with the noisy speech to generate the enhanced speech output 122. The speech at 122 is enhanced by at least for example denoising, such as reducing at least in part noise and interference not associated with the desired speaker 112.

The velocity of the speaker's 112 articulatory gestures can range from for example about −80 cm/second to 80 cm/second (−160˜160 cm/s for propagation path change). This can introduce a corresponding Doppler shift of for example about −100 Hertz (Hz) to about 100 Hz, when the transmitted ultrasound signal's frequency is 20 kHz. Moreover, each articulatory gesture may correspond to a single phoneme lasting for example, about 100 milliseconds (ms) to about 700 ms. To characterize the articulatory gestures, the short-term, high-resolution Doppler shift may be used, while being robust to multipath and frequency-selective fading, such that the signal features from articulatory gestures are alone identified or extracted.

In some embodiments, the ultrasound transmitted by the loudspeaker 150A may comprise a continuous wave (CW) ultrasound signal, such as multiple single tones (e.g., single frequency) continuous waves (CWs) having linearly spaced frequencies. Although modulated CW signals (e.g., frequency modulated continuous wave, orthogonal frequency division multiplexing, and pseudo-noise (PN) sequences) may measure the impulse response to resolve multipath, they may suffer from a low sampling rate problem. A reason is for this is that the modulation processes the signal in segments (e.g., chirp period or symbol period). Thus, each feature point of the modulated CW signal characterizes the motion within a whole segment, which is typically longer than 10 ms (960 samples) at a sampling rate of 96 kHz, so only about 10 to about 70 feature points can be output for each articulatory gesture with a typical duration of about 100 ms to about 700 ms, which may not be sufficient to represent the fine-grained instantaneous velocity of articulatory gesture motion. By comparison, each sampling point of a single tone CW can generate one feature point (Doppler shift estimation) to represent the micro-motion with duration of, for example, 0.01 ms (1/96000) at a sampling rate of 96 kHz. To further resolve the multipath effect and frequency selective fading, multiple single-tone CWs with equal frequency spacing may be combined, which may result in a transmitted ultrasound waveform T(t)=Σᵢ₌₁^{N}Aᵢ cos 2πfᵢt, where N, Aᵢ and fᵢ denote the number of tones, the amplitude and frequency of the i^{th} tone, respectively. And to alleviate the spectral leakage across different tones when generating the spectrogram in a later processing stage, a short time Fourier transform (STFT) window size (e.g., of 1024 points) is a full cycle of all the transmitted tones at a maximum sampling rate (e.g., 48 or 96 kHz via microphone 150B).

Despite the orthogonality in frequency, there may be mutual interference between the speech and articulatory gesture ultrasound, which can cause ambiguity in the Doppler features. For example, harmonics of the speech may interfere with the Doppler features extracted from the articulatory gesture ultrasound. Specifically, the speech harmonics may interfere the Doppler features due to non-linearity of microphone hardware. In some embodiments, the amplitude of the transmitted ultrasound may be adjusted (e.g., decreased), such that the speech signal harmonics (which interfere with the ultrasound and its Doppler) is reduced (or eliminated). Moreover, when the speaker 112 speaks close to the microphone 150B, some of the phonemes (e.g., /p/ and /t/) may blow air flow into the microphone that can generate high-volume noise. Rather than remove the corrupted, noise speech samples, the ML model 120 may be used to characterize the sampling period corresponding to the specific phonemes (e.g., /p/ and /t/ causing the air flow related noise at the microphone.

Referring again to FIG. 1, the ML model 120 may be comprised as a deep neural network (DNN) framework. Moreover, the ML model 120 may be used to correlate the Doppler shift features extracted from the received ultrasound with the speech in the received noisy speech.

In some embodiments, the noisy speech 118B is transformed into a time-frequency spectrogram, which serves as a first input to the ML model 120. In some embodiments, the Doppler shift features are, as noted, extracted from the received ultrasound (corresponding to the articulated gestures) 118A, which serves as a second input to the ML model 120.

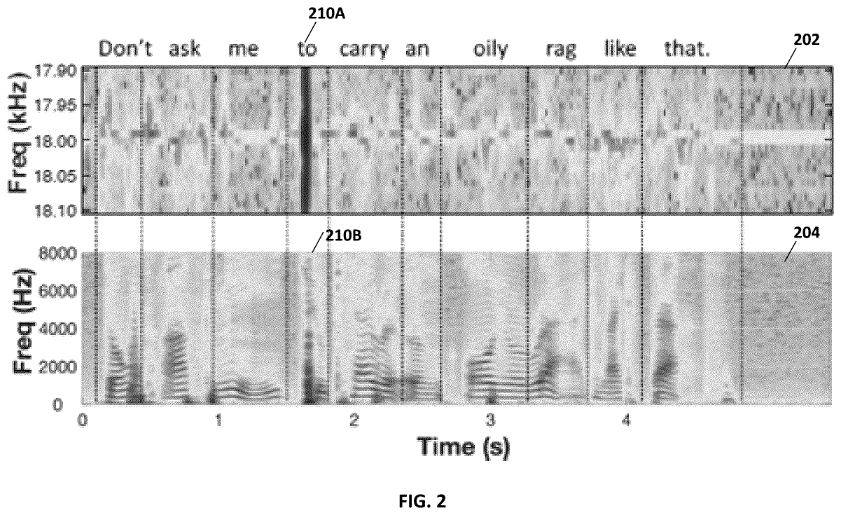

FIG. 2 depicts a simple example of a first spectrogram 202 of the Doppler shift for the phrase “Don't ask me to carry an oily rag like that.” The second spectrogram 204 is the time frequency spectrogram of the same phrase “Don't ask me to carry an oily rag like that” without noise and/or interference to facilitate the explanation of correlating articulatory gestures with speech. In this example, the word “to” 210A in the first spectrogram 202 correlates with the “to” 210B in the second spectrogram 204. In the case of noise being present in the second spectrogram 204, the ML model may be trained to still correlate 210A and 210B. This correlation may then be used to further process “to” 210B in the second spectrogram 204 (e.g., by reducing the noise/interference unrelated to the “to” 210B and/or amplifying the signal associated with “to” 210B).

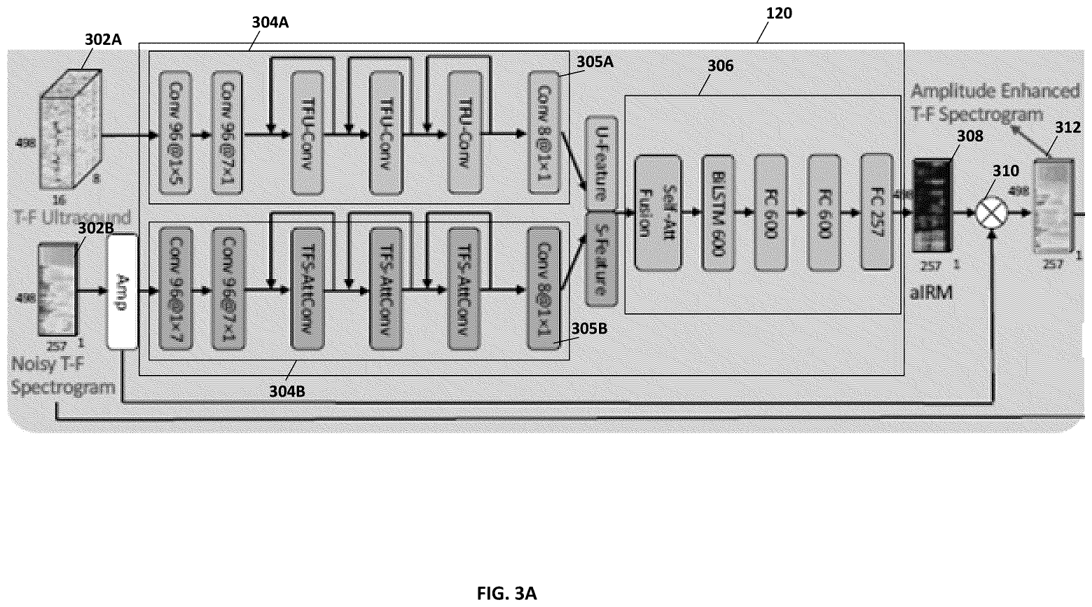

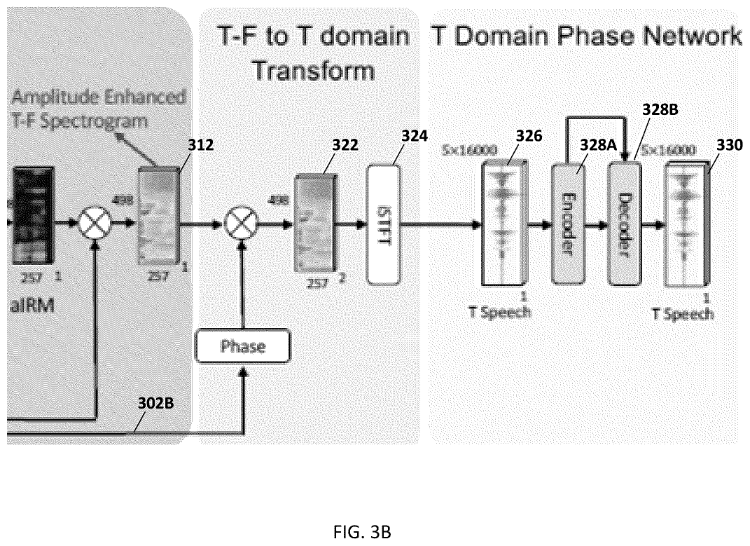

FIG. 3A depicts an example implementation of the ML model 120 and, in a particular DNN framework for the ML model, in accordance with some embodiments. The ML model includes at least a first input 302A and a second input 302B. The first input 302A comprises time frequency (T-F) information representative of the ultrasound 118 (which includes for example the Doppler shift of the articulatory gestures), and the second input 302B comprises time frequency information representative of the noisy speech signal 118B.

The ML model 120 may include one or more layers (each of which form a “subnetwork” and/or a “block,” such as a computational block) 304A that provide feature embedding of the received ultrasound 302A. Likewise, one or more layers 304B provide feature embedding of the received noisy speech spectrogram 302B. The embedding takes the input and generates a lower dimensional representation of the input. At 306, the ultrasound features (which are output by the one or more layers 304A and labeled “U-Feature”) are fused (e.g., concatenated, combined, etc.) with the noisy speech features (which are output by the one or more layers 304B and labeled “S-Feature”).

In the example of speech feature embedding layers 304B, the input 302B is for example a time-frequency (T-F) domain amplitude spectrogram that is represented as Sₙₒᵢₛₑ^{a}∈ [symbol] ^{1×T×F}^{^{a}}·F^{a}=257 is determined by the window size of the short time Fourier transform (STFT). In the example of FIG. 3A, the layers 304B may include 2 two-dimensional convolutional (Conv) layers followed by 3 TFS-Conv layers (labeled “TFS-ATTConv”). The TFS-ATTConv layers may employ both a Residual Network (ResNet) and a self-attention mechanism to learn the global correlation of sound patterns across time-frequency bins. See, e.g., Dacheng Yin, Chong Luo, Zhiwei Xiong, and Wenjun Zeng. Phasen: A phase-and-harmonics-aware speech enhancement network. In Proceedings of AAAI, 2020.

In the example of ultrasound feature embedding layers 304A, the input 302A is represented as U^{s}∈ [symbol] ^{T×F}^{^{s}}^{×C}^{^{s}} where C^{s}=8 is the number of ultrasound tones, and F^{s}=16 is the maximum number Doppler shift frequency bins introduced by the articulatory gestures. As the motion-speed changes continuously, the frequency (F) domain ultrasound features are mainly local Doppler shift features, so small kernels may be used to capture the local Doppler shift feature correlation (e.g., the size of the F domain may be 16). As such, TFU-Conv layers reduce the kernel size of the F domain in all of the 2D convolution layers. To maintain the time alignment of the two modalities (i.e., ultrasound and speech) after feature embedding, the time (T) domain kernel size of the ultrasound path may be kept the same as in the “TFS-AttConv” layers at 304B. In the example of FIG. 3A, the channel number of the two streams (which correspond to ultrasound and speech) can be reduced to Cᵣ^{s}=8 and Cᵣ^{a}=8 by applying a 1×1 2D convolution at 305A-B.

Referring again to the fusion layers 306, the output 308 of the fusion layers may be considered a mask (referred to herein as an “amplitude Ideal Ratio Mask”, aIRM). The mask provides a ratio between the magnitudes of the clean and noisy spectrograms by using the speech and ultrasound inputs. For example, the mask learns the ratio between the targeted (or desired) speaker's clean speech and the noisy speech. To illustrate further, for each time-frequency slot in the spectrogram, the mask provides a ratio between targeted (or desired) speaker's clean speech and the noisy speech so that when the noisy speech is multiplied with the mask, the final output is only (or primarily) the cleaned speech of the targeted/desired speaker. The use of “ideal” refers to an assumption that the desired speaker's speech signal and noise speech signal are independent and have known power spectra. The first set of layers (or subnetwork) of the fusion layers 306 provides two stream feature embedding by using the noisy speech's T-F spectrogram and the concurrent ultrasound Doppler spectrogram and transforming the two-stream feature embedding (of the different ultrasound and speech modes) into the same feature space while maintaining alignment in the time domain. The second set of layers provide a speech and ultrasound fusion subnetwork that concatenates the features of each stream in the frequency dimension along with self-attention layer and BiLSTM layer to further learn the intra- and inter modal correlation from both frequency domain and time domain.

In the first set of layers of the fusion layers 306 for example, a self-attention layer (labeled “Self Att Fusion”) is applied to fuse the concatenated feature maps to let the multi-modal information “crosstalk” with each other. Here, the crosstalk means that the self-attention layers can assist the speech and Doppler features to learn the intra- and inter-modal correlation between each other effectively. The fused features are subsequently fed into the second set of layers including a bi-directional Long short-term memory (BiLSTM, labeled BiLSTM 600) layer followed by three fully connected (FC) layers. The resulting output 308 is a ratio mask (which corresponds to the ratio between targeted clean speech and the noisy speech) that is multiplied 310 with the original noisy amplitude spectrogram 302B to generate the amplitude-enhanced T-F spectrogram 312.

To illustrate further, the ML model 120 aims to appropriately learn the frequency domain features of the speech and ultrasound modalities, and then fuse speech and ultrasound modalities together to exploit the time-frequency domain correlation. The frequency domain of the ultrasound signal features represents a motion velocity (e.g., Doppler shift) of the articulatory gestures, while that of the speech sound represents the frequency characteristics such as harmonics and consonants. As the size of the two modalities' feature maps are different these two feature maps cannot be simply concatenated into a scalar, so the two-stream embedding framework is used to transform the modalities into the same feature space. After the feature embedding, the feature maps of the two streams are concatenated (which is represented as follows): Sᵢₙ^{f}=concat(Mₐ^{a}, Uₐ^{s}), where Sᵢₙ^{f}∈ [symbol] ^{C}^{^{F}}^{×T×F}^{^{as}} and F^{as}=F^{a}+F^{s}. This concatenated feature map is then provided to the fusion subnetwork 306 including the Self-Att Fusion layer (or block) to learn the relationship between the two modalities. Since the meaning of channel in ultrasound sensing and speech is different, a channel self-attention may be used to learn the correlation across different channels, such as the speech channel and ultrasound channel. To enable these two modalities' features to “crosstalk” with each other in the F domain, the self-attention for the F domain is realized by using a learnable transformation matrix on the fused features. The feature after self-attention fusion is concatenated with the original feature and fused by a 1×1 2D convolution. Finally, the whole feature map is fed into a BiLSTM and 3 fully connected (FC) layers to predict the ∈ [symbol] ^{T×F}^{ₘ}^{×1} of the noisy speech. The predicted aIRM is then multiplied 310 with the original noisy speech's amplitude spectrogram 310 to generate the amplitude-enhanced T-F spectrogram 312. The convolutional layers in the multi-modal fusion network 306 may use zero padding, a dilation=1, and a stride=1 to make sure the output feature map size is the same as the input speech/ultrasound spectrogram. Also, each 2D convolutional layer may be followed by batch normalization (BN) and ReLu activation.

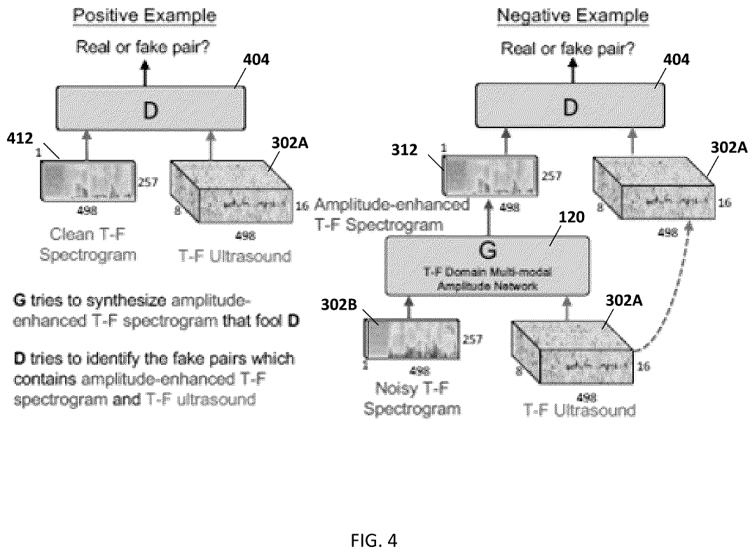

In some embodiments, a conditional generative adversarial network (cGAN) is used in training to denoise the output 308, such as the amplitude-enhanced T-F spectrogram. During the training of the ML model 120, the cGAN may be used to determine the weights of the ML model 120. FIG. 4 shows an example implementation of cGAN-based training of the ML model 120. In the cGAN training model example of FIG. 4, the generator is the ML model 120 as noted with respect to FIG. 3 for example, and the discriminator (D) 404 is used to discriminate whether the enhanced spectrogram 312 corresponds to the ultrasound sensing features.

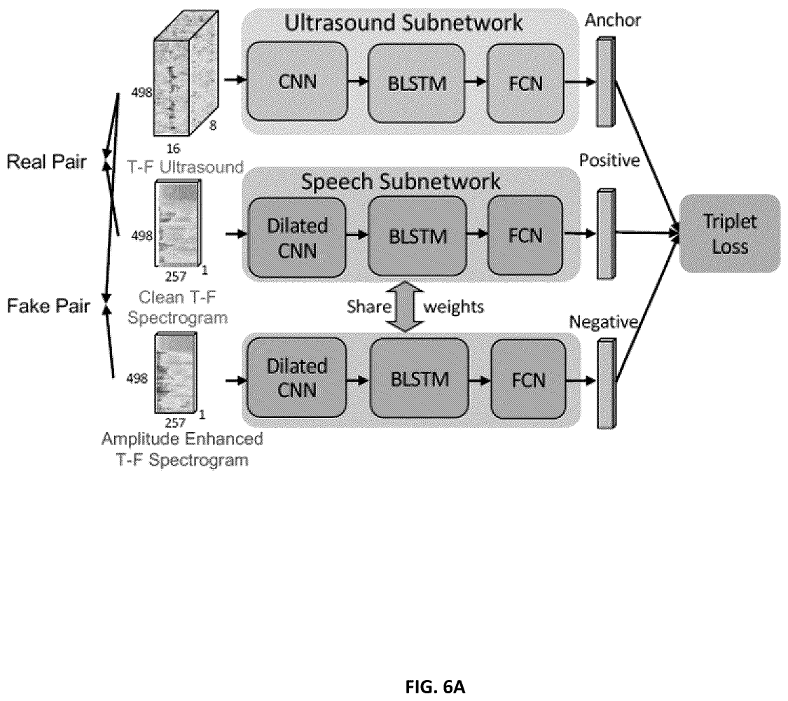

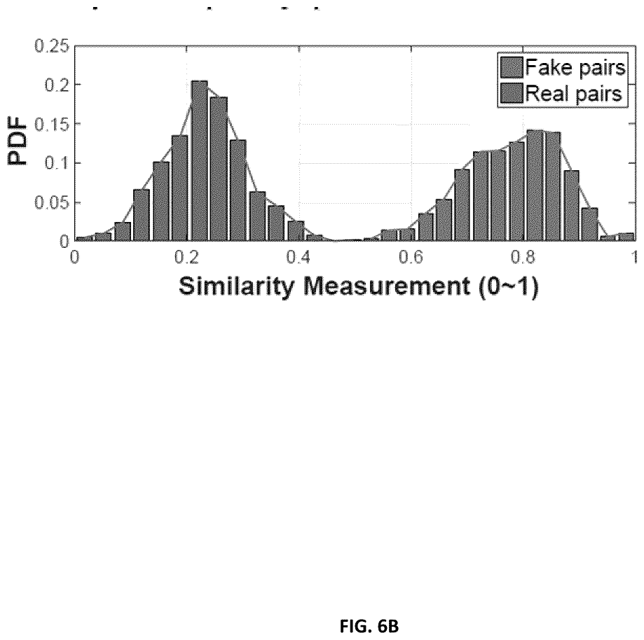

An element of the cGAN is the similarity metric used by the discriminator 404. Unlike traditional GAN applications (which compare between the same type of features), the cGAN is cross-modal, so the cGAN needs to discriminate between different modalities, such as whether the enhanced T-F speech spectrogram matches the ultrasound Doppler spectrogram (e.g., whether they are a “real” or “fake” pair). A cross-modal Siamese neural network may be used to address this issue. The Siamese neural network uses shared weights and model architecture while working in tandem on two different input vectors to compute comparable output vectors. Although a traditional Siamese neural network is used to measure the similarity between two inputs from the same modality (e.g., two images), to enable a cross-modal Siamese neural network, two separate subnetworks may be created as shown at FIG. 6A with the aim to characterize the correspondence between the T-F domain features of the speech and ultrasound, respectively. Referring to FIG. 6A, the basic architecture for these 2 inputs is a CNN-LSTM model. Since human speech contains harmonics and spatial relationship in the F domain, the speech convolutional neural network (CNN) subnetwork uses dilated convolutions for frequency domain context aggregation. The Doppler shifts from ultrasound sensing mostly encompasses local features. Thus, the ultrasound CNN subnetwork only contains traditional convolution layers. Following the convolution, a Bi-LSTM layer is used to learn the long-term time-domain information for both modalities. Finally, three fully connected (FC) layers are introduced to learn two comparable output vectors respectively. The architecture and parameters are not shared in this cross-modal design, which differs from the traditional Siamese networks.

As shown in FIG. 6A, the Triplet loss is used to train the cross-modal Siamese network. The triplet loss function accepts 3 inputs, i.e., an anchor input U^{s} is compared to a positive input S_{gr}^{a} and a negative input Sₒᵤₜ^{a}. It aims to minimize the distance between “real” pair U^{s} and S_{gr}^{a}, and maximize the distance between “fake” pair U^{s} and S_{out′}^{a}. Here, the anchor input U^{s} is the ultrasound sensing features, the positive input S_{gr}^{a} is the corresponding clean speech amplitude spectrogram, and the negative input S_{out′}^{a} is the noisy speech amplitude spectrogram. Thus, the cross-modal Siamese network model minimizes the following Triplet loss:

$$\begin{matrix}{Triplet}_{} ( D ) = {𝔼}_{{U}^{s} , {S}_{g r}^{a} , {S}_{out}^{a} \sim {p}_{data} ( {U}^{s} , {S}_{g r}^{a} , {S}_{out}^{a} )} \\ [ ( {‖ {f}_{u} ( {U}^{s} ) - {f}_{s} ( {S}_{g r}^{a} ) ‖}^{2} - {‖ {f}_{u} ( {U}^{s} ) - {f}_{s} ( {S}_{out}^{a} ) ‖}^{2} + α , 0 ) ]\end{matrix} \qquad ( 1 )$$

where fᵤ is the ultrasound subnetwork, fₛ is the speech subnetwork, and α is a margin distance between “real” and “fake” pairs. FIG. 6B depicts the probability density function (PDF) of outputs, where a smaller value indicates higher similarity. The output PDFs for the real pairs and fake pairs are perfectly separated, which means that the similarity measurement network of FIG. 6A can effectively discriminate whether a pair of speech and ultrasound inputs are generated by the same articulatory gestures.

The similarity measurement may be used as a discriminator 404 (FIG. 4) in the cGAN to further fuse the multi-modal information. The cGAN model aims to not only minimize the mean squared error (MSE) of the speech amplitude spectrogram (relative to the ground-truth), but also guarantee high similarity between the “fake” pair (i.e., the enhanced speech and ultrasound sensing features) and the “real” pair (i.e., the clean speech and ultrasound sensing features).

In the example of FIG. 4, the cGAN is used to add a conditional goal to guide a generator (G) 120 to automatically learn a loss function which well approximates the goal. The generator 120 (which is represented as “G(Sₙₒᵢₛₑ^{a},U^{s})”) takes the noisy speech amplitude spectrogram ultrasound sensing spectrogram U^{s} as the input, wherein the generator G(·) is trained to output amplitude-enhanced T-F spectrogram of the speech Sₒᵤₜ^{a}, which not only minimizes the traditional amplitude MSE loss, but also tries to “fool” an adversarially trained discriminator 404 “D(Sₒᵤₜ^{a}, S_{gr}^{a}, U^{s}”, which strives to discriminate the fake pair (Sₒᵤₜ^{a}, U^{s}) from the “real” pair (S_{gr}^{a}, U^{s}) under the aforementioned triplet loss function. More specifically, The “D” loss is L_{Triplet}(D) (see Eq. (1)), and the “G” loss is

$$\begin{matrix}( G ) = {𝔼}_{{U}^{s} , {S}_{g r}^{a} , {S}_{noise}^{a} \sim {p}_{data} ( {U}^{s} , {S}_{g r}^{a} , {S}_{noise}^{a} ) , z \sim {p}_{z}} \\ {[ {Triplet}_{} ( D ( G ( {U}^{s} , {S}_{noise}^{a} ) , {S}_{g r}^{a} ) , {U}^{s} ) ] + λ ‖ G ( {U}^{s} , {S}_{noise}^{a} ) - {S}_{noise}^{a} ) - {S}_{g r}^{a} ‖}^{2}\end{matrix}$$

where λ∥G(U^{s}, Sₙₒᵢₛₑ^{a})−S_{gr}^{a}∥² is the traditional MSE amplitude loss. Thus, the cGAN disclosed herein represents a general model for cross-modal noise reduction, which may be reused in other sensor fusion problems involving heterogeneous sensing modalities. In other words, the ML model is trained to resolve general multi-modal noise reduction using, for example, modality A (e.g., ultrasound) to recover another modality B (which is corrupted by noise and/or interference). The training uses the cross-modal similarity metric for a pair of modality A and modality B. A cleaner modality B along with modality A thus achieves higher cross-modal similarity. The original multi-modal noise reduction ML model is, as noted, used as a generator (G) model to generate the denoised version of B, and then this version of B is used along with A as the input to a discriminator (D) to make the cross-modal similarity of this pair close to the pair of modality A and clean modality B. By applying such a training approach, the original multi-modal noise reduction machine learning model can be forced to generate a cleaner version of B.

Referring to FIG. 3B, it depicts that the amplitude-enhanced T-F spectrogram output 312 may be further processed to correct phase by performing a phase correction. For example, the phase of the noisy time frequency spectrogram 302B may be used to phase correct the amplitude-enhanced T-F spectrogram output 312. The phase corrected amplitude-enhanced T-F spectrogram is output at 322. Next, an inverse STFT (iSTFT) 324 is applied to transform the time-frequency spectrogram to form a time domain signal 326. For example, iSTFT (e.g., as a fixed 1D convolution layer) may be used to transform the amplitude-enhanced T-F spectrogram into a time domain waveform 326. To fine-tune the phase of the time domain waveform 326, an encoder-decoder 328A-B can be included to reconstruct and cleanup the phase before being output as a time domain waveform 330. The time domain waveform 330, which may correspond to the enhanced output speech 122 at FIG. 1.

Referring to FIG. 3A-3B, the system may thus provide a two stage DNN architecture, which prioritizes the optimization of intelligibility in the T-F domain, and then reconstructs phase in the T domain to improve speech quality. As the articulatory gestures are more related to the speech intelligibility, the multi-modal fusion subnetwork is placed inside the T-F domain.

In some embodiments, there may be provided preprocessing to extract the speech and ultrasound from the output of the microphone 150B (or a stored version of microphone's output). As noted, the microphone receives both the noisy speech (which includes the desired speaker's 112 speech of interest) and the ultrasound (which includes the sensed articulatory gestures). The preprocessing may extract from the microphone output the speech and ultrasound features.

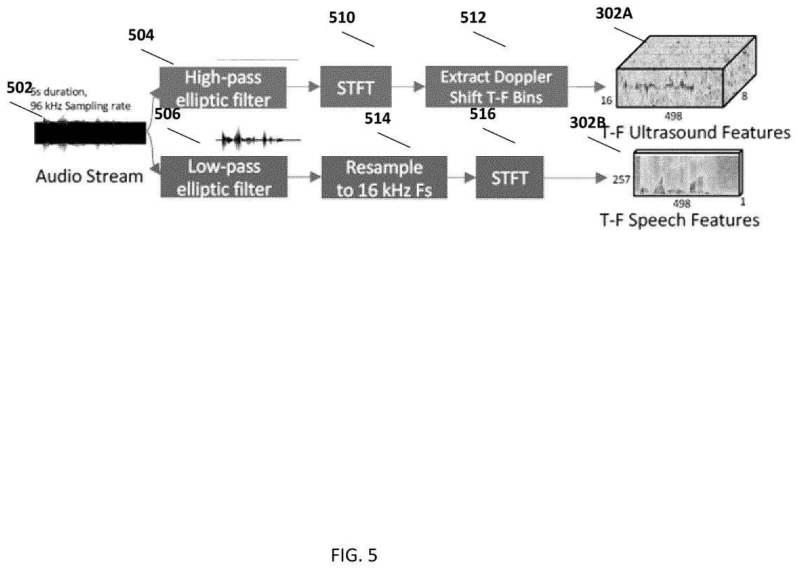

FIG. 5 depicts an example of the preprocessing, in accordance with some embodiments. For example, the audio stream 502 may include the noisy speech (which includes the desired speaker's 112 speech of interest as well as noise and/or interference) and the ultrasound (which includes the sensed articulatory gestures). A high pass filter 504, such as a high pass elliptic filter, is applied to pass the Doppler Frequency information (which is at a higher frequency when compared to the speech audio). A low pass filter 506, such as a low pass elliptic filter, is applied to pass the audio speech information. For example, a low-pass elliptic filter can be set to allow audio below 8 kilohertz top pass (although other cutoff frequencies may be selected). The signal may be resampled to 16 kHz by using a Fourier method (while the final enhanced speech 122 is also sampled at 16 kHz, which is sufficient to characterize the speech signals). The STFT 516 may use a Hann window of length 32 ms, hop length of 10 ms, and FFT size of 512 points under 16 kHz sampling rate, resulting in 100×25×71 complex-valued scalars per second.

In the case of the Doppler, the STFT 510 is applied, which allows the Doppler shift to be identified and extracted at 512 from the time frequency bins of the STFT and provides the time frequency ultrasound 302A. In the case of the speech audio, the filtered audio speech is resampled 514 and then the STFT 516 is applied to form the time frequency noisy speech signal 302B. For example, the high-pass elliptic filter 504 may be used to isolate the signals above 16 kHz, where the ultrasound features are located. To extract the ultrasound sensing features within the T-F domain, the Doppler spectrogram induced by articulatory gestures can be extracted and aligned with the speech spectrogram 302B. A consideration for this step is to balance the tradeoff between time resolution and frequency resolution of the STFT 516 under a limited sampling rate (e.g., 96 kHz maximum). To guarantee time alignment between the speech and ultrasound features, their hop length in the time domain may be the same. The STFT uses a hop length of 10 ms to guarantee 100 frames per second, resulting in about 10 to about 70 frames per articulatory gesture, which is sufficient to characterize the process of an articulatory gesture. Moreover, the frequency resolution (which is determined by the window length) may be as fine-grained as possible to capture the micro-Doppler effects introduced by the articulatory gestures, under the premise that the time resolution is sufficient. A window length 85 ms is the longest length for STFT to make it is shorter than the shortest duration of an articulatory gesture (e.g., about 100 ms). For example, with a 96 kHz sampling rate (or less), the STFT may be computed using a window length 85 ms, hop length of 10 ms, and FFT size of 8192 points, which results in a 11.7 Hz frequency resolution. To mitigate the reflections from relatively static objects, the 3 central frequency bins of the STFT may be removed while leaving 8×2 (16) frequency bins corresponding to Doppler shift [−11.7×8, −11.7) and (11.7, 11.7×8] Hz. Moreover, a min-max normalization may be performed on the ultrasound Doppler spectrogram.

Compared to other speech enhancement yechnology, the system of FIGS. 1 and/or 3A-B (also referred to herein as UltraSE) may improve the speech quality and intelligibility in both noisy and multi-speaker environments. Table 4 shows an example of testing results under a variety of input SNR levels uniformly distributed in [−9, 6] dB. The disclosed UltraSE may outperforms PHASEN and SEGAN across all the 4 metrics. In the 1s+a environment, UltraSE achieves an average 17.25 SiSNR (18.75 ASiSNR) and 3.50 PESQ. In other environments with multi-speaker interference, the ultrasound sensing modality plays a more prominent role, improving SiSNR by 6.04 dB and 9.77 dB on average over the 2 baselines respectively. Even for the hardest case>=2ss+a, UltraSE still achieves 8.97 dB SiSNR and 2.52 PESQ. In addition, UltraSE achieves slightly higher performance than AVSPEECH. Most of the existing speech separation methods can only work with limited number of interfering speakers (about 2 or 3) and without ambient noise. As shown in Table 4, when training the Conv-TasNet by using the “2s+a” dataset, Conv-TasNet achieves good performance in the “2s+a” and “2s” setup, but is not general in other sophisticated environments. In comparison, UltraSE outperforms Conv-TasNet by around 6 dB of SDR or SiSNR, 10% in STOI and 24% in PESQ, under the >3s+a setup.

TABLE 4

| Environment | Methods | SDR | SiSNR | STOI | PESQ |
|---|---|---|---|---|---|
| 1s + a | UltraSE | 17.14 | 17.25 | 0.87 | 3.52 |
| | PHASEN | 15.63 | 15.20 | 0.82 | 3.05 |
| | SEGAN | 5.48 | 5.50 | 0.64 | 2.32 |
| | AVSPEECH | 16.0 | / | / | / |
| | Conv-TasNet | 12.23 | 12.58 | 0.76 | 2.48 |
| 2s + a | UltraSE | 10.55 | 10.65 | 0.76 | 2.80 |
| | PHASEN | 5.20 | 5.22 | 0.65 | 2.23 |
| | SEGAN | 2.01 | 1.96 | 0.54 | 1.69 |
| | AVSPEECH | 10.1 | / | / | / |
| | Conv-TasNet | 10.23 | 10.38 | 0.74 | 2.40 |
| 3s + a | UltraSE | 10.88 | 10.94 | 0.76 | 2.81 |
| | PHASEN | 5.14 | 5.15 | 0.66 | 2.15 |
| | SEGAN | 1.74 | 1.78 | 0.55 | 1.68 |
| | Conv-TasNet | 6.31 | 6.50 | 0.71 | 2.11 |
| >3s + a | UltraSE | 12.10 | 12.17 | 0.78 | 2.66 |
| | PHASEN | 5.13 | 5.13 | 0.67 | 2.14 |
| | SEGAN | 0.71 | 0.72 | 0.53 | 1.67 |
| | Conv-TasNet | 6.23 | 6.41 | 0.71 | 2.15 |
| >=2ss + a | UltraSE | 8.90 | 8.97 | 0.72 | 2.52 |
| | PHASEN | 5.03 | 5.05 | 0.62 | 2.10 |
| | SEGAN | 1.27 | 1.29 | 0.56 | 1.69 |
| | Conv-TasNet | 5.69 | 5.93 | 0.73 | 2.21 |
| 2s | UltraSE | 14.85 | 14.86 | 0.86 | 3.35 |
| | AVSPEECH | 10.3 | / | / | / |
| | Conv-TasNet | 14.98 | 15.02 | 0.85 | 2.97 |

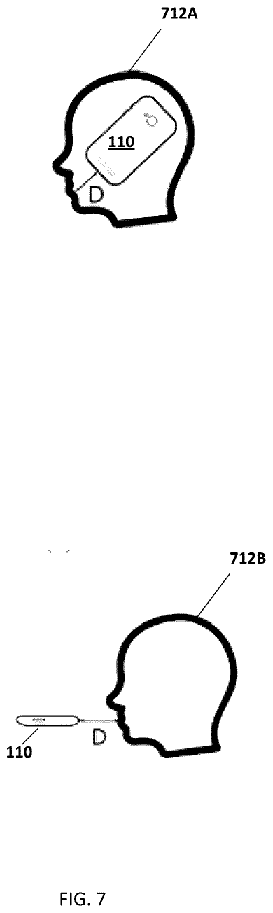

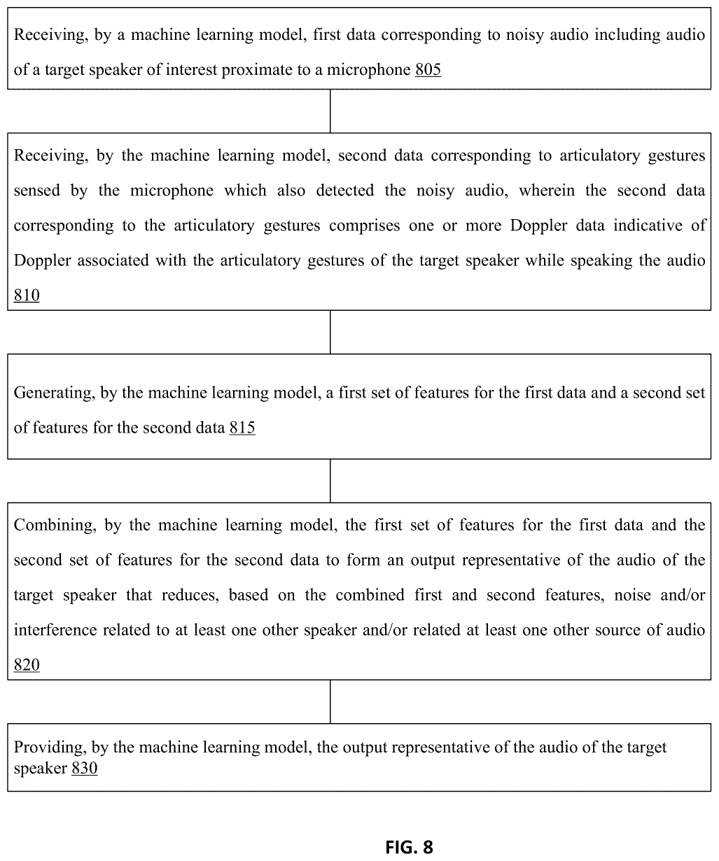

FIG. 7 shows that the user equipment 110 can be oriented such that the desired speaker's 712A face partially occludes the ultrasonic signals. When this is the case, the ML model 120 is trained to accommodate this orientation as well as trained to accommodate this orientation of 712B. In some embodiments, sensors in the user equipment may detect which of the holding styles is being used (e.g., 712A or 712B), and this holding style may be used to select a corresponding ML model 120 (which is trained for the selected holding style). In other words, two ML models 120 may be implemented (e.g., one for the holding style of 712A and one for the holding style of 712B).

FIG. 8 depicts a process flow chart for processing speech audio, in accordance with some embodiments.

At 805, a machine learning model may receive a first data corresponding to noisy audio including audio of a target speaker of interest proximate to a microphone, in accordance with some embodiments. For example, the machine learning model 120 (see, e.g., FIG. 1 and/or FIG. 3) may receive first data, such as noisy speech audio 118B (see, also, 302B) (which includes noise and/or interference as well as the desired speaker's 112 speech audio). The speaker of interest is proximate to a microphone in the sense that the speaker of interest is needs to be within a threshold distance from the microphone to enable detection of the articulatory gesture related Doppler of the speaker of interest while receiving the audio of the speaker. The threshold distance may be no more than 12 inches, although the threshold distance may be larger or smaller.

At 810, the machine learning model may receive a second data corresponding to articulatory gestures sensed by the microphone which also detected the noisy audio, wherein the second data corresponding to the articulatory gestures comprises one or more Doppler data indicative of Doppler associated with the articulatory gestures of the target speaker while speaking the audio, in accordance with some embodiments. For example, the machine learning model 120 (see, e.g., FIG. 1 and/or FIG. 3) may receive second data 118A (see, also, 302A) that corresponds to articulatory gestures sensed by the microphone 150B which is also used to detect the noisy audio data 118A. As noted, the articulatory gestures represent Doppler data and, in particular, the Doppler associated with the articulatory gestures of the target speaker 112 while speaking the audio. Moreover, the articulatory gestures of the target (or desired) speaker 112 may include gestures associated with the target speaker's speech including mouth gestures, lip gestures, tongue gestures, jaw gestures, vocal cord gestures, and/or other speech related organs, which can generate Doppler that can be detected by microphone 150B.

At 815, the machine learning model may generate a first set of features for the first data and a second set of features for the second data, in accordance with some embodiments. For example, the machine learning model may receive time-frequency data, such as the noisy audio spectrogram at 302B. In this example, the ML model 120 may process the received data into features. In some embodiments, the ML model may include a second set of convolutional layers, such as the feature embedding layers 304B. And, the second set of convolutional layers may be used to provide feature embedding for the second data, wherein the second data is in the time-frequency domain. In the example of FIG. 3A, the feature embedding outputs “U-Feature”, which corresponds to at least one feature for the ultrasound articulatory gestures. In some embodiments, the ML model may include a first set of convolutional layers for feature embedding (see, e.g., layers 304B) of the noisy speech data. And, the first set of convolutional layers may be used to provide feature embedding for the first data, wherein the first data is in the time-frequency domain. In the example of FIG. 3A, the feature embedding outputs “S-Feature”, which corresponds to at least one feature for the noisy speech data. The term “set” refers to at least one of an item.

At 820, the machine learning model may combine the first set of features for the first data and the second set of features for the second data to form an output representative of the audio of the target speaker that reduces, based on the combined first and second features, noise and/or interference related to at least one other speaker and/or related at least one other source of audio, in accordance with some embodiments. For example, the fusion layer 306 of FIG. 3A may be used to combine (e.g., in a frequency domain) the first set of features for the first data and the second set of features for the second data. The reduction of noise and/or interference is related to noise caused by at least one other speaker (e.g., other speaker 114A) and/or at least one other source of audio (e.g., 114C).

At 830, the machine learning model may provide the output representative of the audio of the target speaker, in accordance with some embodiments. For example, the output may correspond to the time-frequency data, such as the time frequency spectrogram 312 which has been enhanced by reducing noise and/or interference. Alternatively, or additionally, the output may correspond to phase corrected speech, such as speech 326 and/or 330 described in the example of FIG. 3B above.

In some embodiments, a loudspeaker, such as the loudspeaker 15A0 may generate ultrasound towards at least the target speaker 112, such that the ultrasound is reflected by the articulatory gestures of the target speaker (e.g., while the target speaker is speaking and moving lips, mouth, and/or the like) and then detected (as ultrasound) by the microphone 150B. Although some of the examples refer to a microphone or a loudspeaker, a plurality of microphones and/or loudspeakers may be used as well. As noted above, the ultrasound may be generated as a plurality of continuous wave (CW) single frequency tones.

In some embodiments, an indication may be received. This indication may provide information regarding an orientation of a user equipment 110 as shown at the example of FIG. 7. The indication may be used to select which of a plurality of ML models (e.g., where a first ML model is trained at a first orientation and a second ML model is trained at a second orientation).

In some embodiments, preprocessing may be performed as described with respect to the example of FIG. 5. For example, a single stream 502 of data (which is obtained from the microphone 150B) may be received and then preprocessed to extract the first data comprising noisy audio (e.g., 302B) and to extract the second data comprising the articulatory gestures (e.g., 302A).

In some embodiments, phase correction maybe performed. For example, phase correction of the output 312 of the ML model 120 may be performed as noted above with respect to the example of FIG. 3B.

In some embodiments, the machine learning model 120 is trained using a conditional generative adversarial network. Referring to the example of FIG. 4, the conditional generative adversarial network may use the machine learning model 120 as a generator (G) and use a discriminator (D) that learns a correlation between heterogeneous feature modalities comprising Doppler features and audible speech spectrogram (an example of which is noted above with respect to FIG. 6A). For example, during training of the machine learning model 120, the generator is used to output a noise-reduced representation of audible speech of the target speaker (as shown and described in the example of FIG. 4), and a discriminator (D, as shown and described with respect to FIGS. 4 and 6A) is used to receive as a first input the noise-reduced representation of audible speech of the target speaker, receive as a second input a noisy representation of audible speech of the target speaker, and output, using a cross modal similarity metric, a cross-modal indication of similarity to train the machine learning model. In the case of conditional GAN, the discriminator uses positive and negative examples.

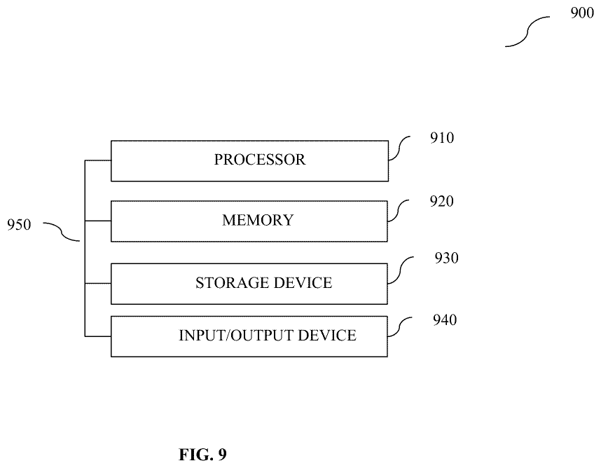

In some implementations, the current subject matter may be configured to be implemented in a system 900, as shown in FIG. 9. For example, the user equipment 110 may be implemented at least in part using the system 100. Moreover, the preprocessing, ML model 120, and/or other aspects disclosed herein may be at least in part physically comprised on system 900. The system 900 may include a processor 910, a memory 920, a storage device 930, and an input/output device 940. Each of the components 910, 920, 930 and 940 may be interconnected using a system bus 950. The processor 910 may be configured to process instructions for execution within the system 900. In some implementations, the processor 910 may be a single-threaded processor. In alternate implementations, the processor 910 may be a multi-threaded processor. In some implementations, the processor 910 may comprise one or more of the following: at least one graphics processor unit (GPU), at least one artificial intelligence (AI) chip, at least one ML chip, a neural engine (e.g., specialized hardware that can do fast inference or fast training for neural networks), at least one single core processor, and/or at least one multi-core processor. The processor 910 may be further configured to process instructions stored in the memory 920 or on the storage device 930, including receiving or sending information through the input/output device 940. The memory 920 may store information within the system 900. In some implementations, the memory 920 may be a computer-readable medium. In alternate implementations, the memory 920 may be a volatile memory unit. In yet some implementations, the memory 920 may be a non-volatile memory unit. The storage device 930 may be capable of providing mass storage for the system 900. In some implementations, the storage device 930 may be a computer-readable medium. In alternate implementations, the storage device 930 may be a floppy disk device, a hard disk device, an optical disk device, a tape device, non-volatile solid state memory, or any other type of storage device. The input/output device 940 may be configured to provide input/output operations for the system 900. For example, the input/output may include transceivers to interface with wireless networks, such as cellular, WiFi™, and the like, and/or wired networks. In some implementations, the input/output device 940 may include a keyboard and/or pointing device. In alternate implementations, the input/output device 940 may include a display unit for displaying graphical user interfaces.

In view of the above-described implementations of subject matter this application discloses the following list of examples, wherein one feature of an example in isolation or more than one feature of said example taken in combination and, optionally, in combination with one or more features of one or more further examples are further examples also falling within the disclosure of this application:
Example 1. A method comprising: receiving, by a machine learning model, first data corresponding to noisy audio including audio of a target speaker of interest proximate to a microphone; receiving, by the machine learning model, second data corresponding to articulatory gestures sensed by the microphone which also detected the noisy audio, wherein the second data corresponding to the articulatory gestures comprises one or more Doppler data indicative of Doppler associated with the articulatory gestures of the target speaker while speaking the audio; generating, by the machine learning model, a first set of features for the first data and a second set of features for the second data; combining, by the machine learning model, the first set of features for the first data and the second set of features for the second data to form an output representative of the audio of the target speaker that reduces, based on the combined first and second features, noise and/or interference related to at least one other speaker and/or related at least one other source of audio; and providing, by the machine learning model, the output representative of the audio of the target speaker.
Example 2. The method of Example 1, further comprising: emanating, via a loudspeaker, ultrasound towards at least the target speaker, wherein the ultrasound is reflected by the articulatory gestures and detected by the microphone.
Example 3. The method of Examples 1-2 further comprising: receiving an indication of an orientation of a user equipment including the microphone and the loudspeaker; selecting, using the received indication, the machine learning model.
Example 4. The method of Examples 1-3, wherein the ultrasound comprises a plurality of continuous wave (CW) single frequency tones.
Example 5. The method of Examples 1-4, wherein the articulatory gestures comprise gestures associated with the target speaker's speech including mouth gestures, lip gestures, tongue gestures, jaw gestures, vocal cord gestures, and/or other speech related organs.
Example 6. The method of Examples 1-5, wherein the generating, by the machine learning model, the first set of features for the first data and the second set of features for the second data further comprises: using, a first set of convolutional layers to provide feature embedding for the first data, wherein the first data is in a time-frequency domain; and using, a second set of convolutional layers to provide feature embedding for the second data, wherein the second data is in the time-frequency domain.
Example 7. The method of Examples 1-6, wherein the first set of features and the second set of features are combined in the time-frequency domain while maintaining time alignment between the first and second set of features.
Example 8. The method of Examples 1-7, wherein the machine learning model includes one or more fusion layers to combine, in a frequency domain, the first set of features for the first data and the second set of features for the second data.
Example 9. The method of Examples 1-8 further comprising: receiving a single stream of data obtained from the microphone; and preprocessing the single stream to extract the first data comprising noisy audio and to extract the second data comprising the articulatory gestures.
Example 10. The method of Examples 1-9 further comprising: correcting the phase of the output representative of the audio of the target speaker.
Example 11. The method of Examples 1-10, wherein during training of the machine learning model, a generator comprising the machine learning model is used to output a noise-reduced representation of audible speech of the target speaker, and a discriminator is used to receive as a first input the noise-reduced representation of audible speech of the target speaker, receive as a second input a noisy representation of audible speech of the target speaker, and output, using a cross modal similarity metric, a cross-modal indication of similarity to train the machine learning model.
Example 12. An apparatus comprising: at least one processor; and at least one memory including instruction which when executed by the at least one processor causes operations comprising: receiving, by a machine learning model, first data corresponding to noisy audio including audio of a target speaker of interest proximate to a microphone; receiving, by the machine learning model, second data corresponding to articulatory gestures sensed by the microphone which also detected the noisy audio, wherein the second data corresponding to the articulatory gestures comprises one or more Doppler data indicative of Doppler associated with the articulatory gestures of the target speaker while speaking the audio; generating, by the machine learning model, a first set of features for the first data and a second set of features for the second data; combining, by the machine learning model, the first set of features for the first data and the second set of features for the second data to form an output representative of the audio of the target speaker that reduces, based on the combined first and second features, noise and/or interference related to at least one other speaker and/or related at least one other source of audio; and providing, by the machine learning model, the output representative of the audio of the target speaker.
Example 13. The system of Example 12, further comprising: emanating, via a loudspeaker, ultrasound towards at least the target speaker, wherein the ultrasound is reflected by the articulatory gestures and detected by the microphone.
Example 14. The system of Examples 12-13 further comprising: receiving an indication of an orientation of a user equipment including the microphone and the loudspeaker; selecting, using the received indication, the machine learning model.
Example 15. The system of Examples 12-14, wherein the ultrasound comprises a plurality of continuous wave (CW) single frequency tones.
Example 16. The system of Examples 12-15, wherein the articulatory gestures comprise gestures associated with the target speaker's speech including mouth gestures, lip gestures, tongue gestures, jaw gestures, vocal cord gestures, and/or other speech related organs.
Example 17. The system of Examples 12-16, wherein the generating, by the machine learning model, the first set of features for the first data and the second set of features for the second data further comprises: using, a first set of convolutional layers to provide feature embedding for the first data, wherein the first data is in a time-frequency domain; and using, a second set of convolutional layers to provide feature embedding for the second data, wherein the second data is in the time-frequency domain.
Example 18. The system of Examples 12-17, wherein the first set of features and the second set of features are combined in the time-frequency domain while maintaining time alignment between the first and second set of features.
Example 19. The system of Examples 12-18, wherein the machine learning model includes one or more fusion layers to combine, in a frequency domain, the first set of features for the first data and the second set of features for the second data.
Example 20. The system of Examples 12-19 further comprising: receiving a single stream of data obtained from the microphone; and preprocessing the single stream to extract the first data comprising noisy audio and to extract the second data comprising the articulatory gestures.
Example 21. The system of Examples 12-20 further comprising: correcting the phase of the output representative of the audio of the target speaker.
Example 22. The system of Examples 12-21, wherein during training of the machine learning model, a generator comprising the machine learning model is used to output a noise-reduced representation of audible speech of the target speaker, and a discriminator is used to receive as a first input the noise-reduced representation of audible speech of the target speaker, receive as a second input a noisy representation of audible speech of the target speaker, and output, using a cross modal similarity metric, a cross-modal indication of similarity to train the machine learning model.
Example 23. A non-transitory computer-readable storage medium including instruction which when executed by at least one processor causes operations comprising: receiving, by a machine learning model, first data corresponding to noisy audio including audio of a target speaker of interest proximate to a microphone; receiving, by the machine learning model, second data corresponding to articulatory gestures sensed by the microphone which also detected the noisy audio, wherein the second data corresponding to the articulatory gestures comprises one or more Doppler data indicative of Doppler associated with the articulatory gestures of the target speaker while speaking the audio; generating, by the machine learning model, a first set of features for the first data and a second set of features for the second data; combining, by the machine learning model, the first set of features for the first data and the second set of features for the second data to form an output representative of the audio of the target speaker that reduces, based on the combined first and second features, noise and/or interference related to at least one other speaker and/or related at least one other source of audio; and providing, by the machine learning model, the output representative of the audio of the target speaker.

One or more aspects or features of the subject matter described herein can be realized in digital electronic circuitry, integrated circuitry, specially designed application specific integrated circuits (ASICs), field programmable gate arrays (FPGAs) computer hardware, firmware, software, and/or combinations thereof. These various aspects or features can include implementation in one or more computer programs that are executable and/or interpretable on a programmable system including at least one programmable processor, which can be special or general purpose, coupled to receive data and instructions from, and to transmit data and instructions to, a storage system, at least one input device, and at least one output device. The programmable system or computing system may include clients and servers. A client and server are generally remote from each other and typically interact through a communication network. The relationship of client and server arises by virtue of computer programs running on the respective computers and having a client-server relationship to each other.

These computer programs, which can also be referred to as programs, software, software applications, applications, components, or code, include machine instructions for a programmable processor, and can be implemented in a high-level procedural and/or object-oriented programming language, and/or in assembly/machine language. As used herein, the term “machine-readable medium” refers to any computer program product, apparatus and/or device, such as for example magnetic discs, optical disks, memory, and Programmable Logic Devices (PLDs), used to provide machine instructions and/or data to a programmable processor, including a machine-readable medium that receives machine instructions as a machine-readable signal. The term “machine-readable signal” refers to any signal used to provide machine instructions and/or data to a programmable processor. The machine-readable medium can store such machine instructions non-transitorily, such as for example as would a non-transient solid-state memory or a magnetic hard drive or any equivalent storage medium. The machine-readable medium can alternatively, or additionally, store such machine instructions in a transient manner, such as for example, as would a processor cache or other random access memory associated with one or more physical processor cores.

The subject matter described herein can be embodied in systems, apparatus, methods, and/or articles depending on the desired configuration. The implementations set forth in the foregoing description do not represent all implementations consistent with the subject matter described herein. Instead, they are merely some examples consistent with aspects related to the described subject matter. Although a few variations have been described in detail above, other modifications or additions are possible. In particular, further features and/or variations can be provided in addition to those set forth herein. For example, the implementations described above can be directed to various combinations and subcombinations of the disclosed features and/or combinations and subcombinations of several further features disclosed above. In addition, the logic flows depicted in the accompanying figures and/or described herein do not necessarily require the particular order shown, or sequential order, to achieve desirable results. Other implementations may be within the scope of the following claims.

1. A method comprising:
receiving, by a machine learning model, first data corresponding to noisy audio including audio of a target speaker of interest proximate to a microphone;
receiving, by the machine learning model, second data corresponding to articulatory gestures sensed by the microphone which also detected the noisy audio, wherein the second data corresponding to the articulatory gestures comprises one or more Doppler data indicative of Doppler associated with the articulatory gestures of the target speaker while speaking the audio;
generating, by the machine learning model, a first set of features for the first data and a second set of features for the second data;
combining, by the machine learning model, the first set of features for the first data and the second set of features for the second data to form an output representative of the audio of the target speaker that reduces, based on the combined first and second features, noise and/or interference related to at least one other speaker and/or related at least one other source of audio; and
providing, by the machine learning model, the output representative of the audio of the target speaker.

2. The method of claim 1, further comprising:
emanating, via a loudspeaker, ultrasound towards at least the target speaker, wherein the ultrasound is reflected by the articulatory gestures and detected by the microphone.

3. The method of claim 2 further comprising:
receiving an indication of an orientation of a user equipment including the microphone and the loudspeaker; and
selecting, using the received indication, the machine learning model.

4. The method of claim 2, wherein the ultrasound comprises a plurality of continuous wave (CW) single frequency tones.

5. The method of claim 1, wherein the articulatory gestures comprise gestures associated with the target speaker's speech including mouth gestures, lip gestures, tongue gestures, jaw gestures, vocal cord gestures, and/or other speech related organs.

6. The method of claim 1, wherein the generating, by the machine learning model, the first set of features for the first data and the second set of features for the second data further comprises:
using, a first set of convolutional layers to provide feature embedding for the first data, wherein the first data is in a time-frequency domain; and
using, a second set of convolutional layers to provide feature embedding for the second data, wherein the second data is in the time-frequency domain.

7. The method of claim 6, wherein the first set of features and the second set of features are combined in the time-frequency domain while maintaining time alignment between the first and second set of features.

8. The method of claim 7, wherein the machine learning model includes one or more fusion layers to combine, in a frequency domain, the first set of features for the first data and the second set of features for the second data.

9. The method of claim 1 further comprising:
receiving a single stream of data obtained from the microphone; and
preprocessing the single stream to extract the first data comprising noisy audio and to extract the second data comprising the articulatory gestures.

10. The method of claim 1 further comprising:
correcting a phase of the output representative of the audio of the target speaker.

11. The method of claim 1, wherein during training of the machine learning model, a generator comprising the machine learning model is used to output a noise-reduced representation of audible speech of the target speaker, and a discriminator is used to receive as a first input the noise-reduced representation of audible speech of the target speaker, receive as a second input a noisy representation of audible speech of the target speaker, and output, using a cross modal similarity metric, a cross-modal indication of similarity to train the machine learning model.

12. A system comprising:
at least one processor; and
at least one memory including instruction which when executed by the at least one processor causes operations comprising:
receiving, by a machine learning model, first data corresponding to noisy audio including audio of a target speaker of interest proximate to a microphone;
receiving, by the machine learning model, second data corresponding to articulatory gestures sensed by the microphone which also detected the noisy audio, wherein the second data corresponding to the articulatory gestures comprises one or more Doppler data indicative of Doppler associated with the articulatory gestures of the target speaker while speaking the audio;
generating, by the machine learning model, a first set of features for the first data and a second set of features for the second data;
combining, by the machine learning model, the first set of features for the first data and the second set of features for the second data to form an output representative of the audio of the target speaker that reduces, based on the combined first and second features, noise and/or interference related to at least one other speaker and/or related at least one other source of audio; and
providing, by the machine learning model, the output representative of the audio of the target speaker.

13. The system of claim 12, further comprising:
emanating, via a loudspeaker, ultrasound towards at least the target speaker, wherein the ultrasound is reflected by the articulatory gestures and detected by the microphone.

14. The system of claim 13 further comprising:
receiving an indication of an orientation of a user equipment including the microphone and the loudspeaker; and
selecting, using the received indication, the machine learning model.

15. The system of claim 13, wherein the ultrasound comprises a plurality of continuous wave (CW) single frequency tones.

16. The system of claim 12, wherein the articulatory gestures comprise gestures associated with the target speaker's speech including mouth gestures, lip gestures, tongue gestures, jaw gestures, vocal cord gestures, and/or other speech related organs.

17. The system of claim 12, wherein the generating, by the machine learning model, the first set of features for the first data and the second set of features for the second data further comprises:
using, a first set of convolutional layers to provide feature embedding for the first data, wherein the first data is in a time-frequency domain; and
using, a second set of convolutional layers to provide feature embedding for the second data, wherein the second data is in the time-frequency domain.

18. The system of claim 17, wherein the first set of features and the second set of features are combined in the time-frequency domain while maintaining time alignment between the first and second set of features.

19. The system of claim 18, wherein the machine learning model includes one or more fusion layers to combine, in a frequency domain, the first set of features for the first data and the second set of features for the second data.

20. The system of claim 12 further comprising:
receiving a single stream of data obtained from the microphone; and
preprocessing the single stream to extract the first data comprising noisy audio and to extract the second data comprising the articulatory gestures.

21. The system of claim 12 further comprising:
correcting a phase of the output representative of the audio of the target speaker.

22. The system of claim 12, wherein during training of the machine learning model, a generator comprising the machine learning model is used to output a noise-reduced representation of audible speech of the target speaker, and a discriminator is used to receive as a first input the noise-reduced representation of audible speech of the target speaker, receive as a second input a noisy representation of audible speech of the target speaker, and output, using a cross modal similarity metric, a cross-modal indication of similarity to train the machine learning model.

23. A non-transitory computer-readable storage medium including instruction which when executed by at least one processor causes operations comprising:
receiving, by a machine learning model, first data corresponding to noisy audio including audio of a target speaker of interest proximate to a microphone;
receiving, by the machine learning model, second data corresponding to articulatory gestures sensed by the microphone which also detected the noisy audio, wherein the second data corresponding to the articulatory gestures comprises one or more Doppler data indicative of Doppler associated with the articulatory gestures of the target speaker while speaking the audio;
generating, by the machine learning model, a first set of features for the first data and a second set of features for the second data;
combining, by the machine learning model, the first set of features for the first data and the second set of features for the second data to form an output representative of the audio of the target speaker that reduces, based on the combined first and second features, noise and/or interference related to at least one other speaker and/or related at least one other source of audio; and
providing, by the machine learning model, the output representative of the audio of the target speaker.
